(19) United States
(12) Patent Application Publication
(10) Pub. No.: US 2009/0003833 A1
(43) Pub. Date: Jan. 1, 2009

(54) OPTOMECHANICAL DEVICE AND ITS OPTICAL TRANSMITTING ELEMENT

(76) Inventors: Ming-Hsing CHUNG, Taoyuan Hsien (TW); Te-Shen Yang, Taoyuan Hsien (TW)

Correspondence Address: BIRCH STEWART KOLASCH & BIRCH, PO BOX 747, FALLS CHURCH, VA, 22040-0747, US

(21) Appl. No.: 12/027,841

(22) Filed: Feb. 7, 2008

(30) Foreign Application Priority Data
Jun. 29, 2007 (TW) 096123701

(51) Int. Cl. H04B 10/04

(52) U.S. Cl. 398/136

(57) ABSTRACT

An optomechanical structure includes a housing, a first optical transmitting element, a second optical transmitting element and a filtering element. The first optical transmitting element and the second optical transmitting element are disposed in the housing. The filtering element is disposed between the first optical transmitting element and the second optical transmitting element. The first optical transmitting element has a first body, a first transmitting portion, a first holding portion and a first filtering portion. The first transmitting portion is coupled to the first body, and the first carrying is connected to the first transmitting portion. The first filtering portion is disposed corresponding to the first transmitting portion and is positioned on the first holding portion.

### CROSS REFERENCE TO RELATED APPLICATIONS

This Non-provisional application claims priority under 35 U.S.C. §119(a) on Patent Application No(s). 096123701 filed in Taiwan, Republic of China on Jun. 29, 2007, the entire contents of which are hereby incorporated by reference.

### BACKGROUND OF THE INVENTION

1. Field of Invention

The invention relates to an optical communication module and, in particular, to an optomechanical device and its optical transmitting element applied in an optical communication module.

2. Related Art

Due to the development of technology, information can be obtained through a wired network or a wireless network. Therefore, the demand for the transmitting speed and receiving speed through the network is correspondingly increased. At present, the optical communication network has been developed. In the optical communication network system, an optomechanical device is an indispensable element for transmitting and receiving optical data.

FIG. 1 is an exploded diagram showing a conventional optomechanical device and FIG. 2 is a cross-sectional diagram showing the optomechanical device of FIG. 1. The conventional optomechanical device 1, such as an optical transceiver, includes a housing 11, a filtering element 12, an optical transmitting element 13 and an optical receiving element 14. The housing 11 has a first hole 111, a second hole 112 and a third hole 113, which are connected to and approximately perpendicular to each other. The filtering element 12 is disposed in the first hole 111, and has a first holding portion 121, a second holding portion 122, a first filtering portion 123 and a second filtering portion 124. The first filtering portion 123 is disposed on the first holding portion 121. The second filtering portion 124 is horizontally disposed on the second holding portion 122. The first filtering portion 123 and the filtering element 12 form an angle of about 45 degrees. The first filtering portion 123 is a 45-degree filter and the second filter 124 is a zero-degree filter.

The optical receiving element 14 of the conventional optomechanical device 1 includes a receiving terminal 141, which is disposed in the second hole 112 and adjacent to the second filtering portion 124 of the filtering element 12. The optical transmitting element 13 has a light source terminal 131, which is disposed in the third hole 113 and adjacent to the first filtering portion 123 of the filtering element 12. Herein, the optical transmitting element 13 is capable of transforming an electrical signal into an optical signal, and the optical receiving element 14 is capable of transforming an optical signal into an electrical signal. Additionally, a fiber O is usually disposed in the optomechanical device 1. The fiber O is disposed at one terminal of the third hole 113 and is disposed opposite to the optical transmitting element 13 for the optical signal transmission.

As mentioned above, many specifications must be defined for disposing and fixing the first filtering portion 123 and the second filtering portion 124, and the lathe and manufacturing tool with high precision are needed to manufacture the filtering element 12. Additionally, to achieve high quality, the precise orientation structure and the precise alignment tool are needed to configure the optical transmitting element 13, the optical receiving element 14 and the filtering element 12. However, the dimensions of the filtering portion 123 and the second filtering portion 12 have to be increased for solving the above problem. Thus, the manufacturing cost is increased and the production yield is decreased.

Therefore, there is a need to provide an optomechanical device, which does not need the precision lathe and orientation structure, thereby reducing the manufacturing cost and increasing the transmission quality.

### SUMMARY OF THE INVENTION

In view of the foregoing, an object of the present invention is to provide an optomechanical device and an optical transmitting element thereof, which can reduce the manufacturing cost and increase the transmission quality without utilizing the conventional precision lathe and orientation structure.

To achieve the above, the present invention discloses an optomechanical device, which includes a housing, a first optical transmitting element, a second optical transmitting element and a filtering element. The first optical transmitting element and the second optical transmitting element are disposed in the housing. The filtering element is disposed between the first optical transmitting element and the second optical transmitting element. The first optical transmitting element has a first body, a first transmitting portion, a first holding portion and a first filtering portion. The first transmitting portion is coupled to the first body, and the first holding portion is connected to the first transmitting portion. The first filtering portion is disposed corresponding to the first transmitting portion and is positioned on the first carrying portion.

To achieve the above, the present invention also discloses an optical transmitting element, which includes a body, a transmitting portion, a holding portion and a filtering portion. The transmitting portion couples to the body, and the carrying portion connects to the transmitting portion. The filtering portion is disposed corresponding to the transmitting portion and is positioned on the holder.

As mentioned above, the optomechanical device has the first filtering portion, the first holding portion and the first transmitting portion integrated on the first body. The first holding portion is disposed on the first transmitting portion and the first filtering portion is disposed corresponding to the first transmitting portion and is positioned on the first holding portion. Therefore, the first filtering portion can be easily fixed on the first holding portion of the first optical transmitting element and aligned to the first transmitting portion without utilizing the conventional precise orientation structure and alignment tool. Accordingly, the precision lathe that used to manufacture the conventional optomechanical device is unnecessary. In addition, the dimension of the first filtering portion is not limited, and can include smaller filtering plate, so that the material cost of the optomechanical device can be reduced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is an exploded diagram showing the conventional optomechanical device;

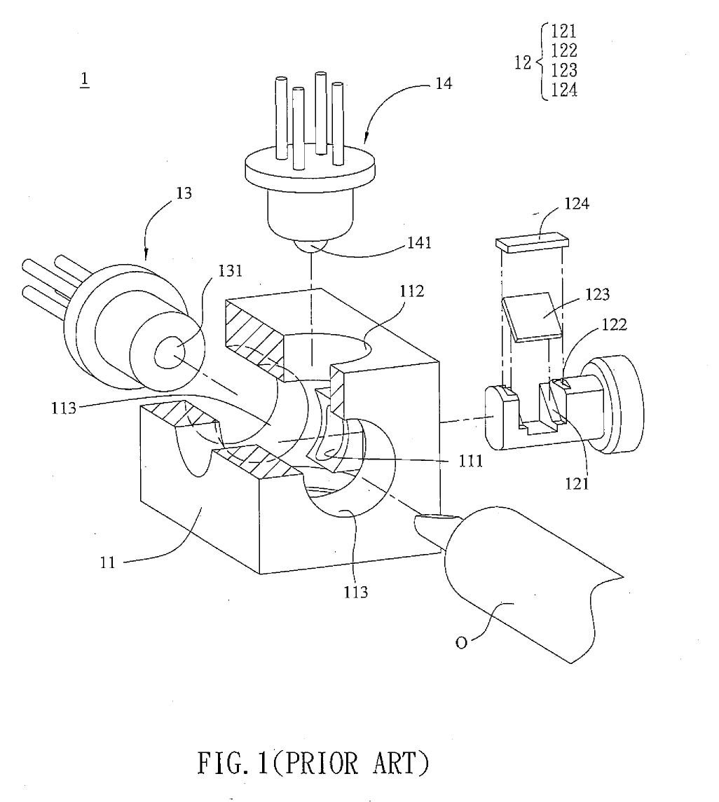

FIG. 2 is a cross-sectional diagram showing the optomechanical device of FIG. 1;

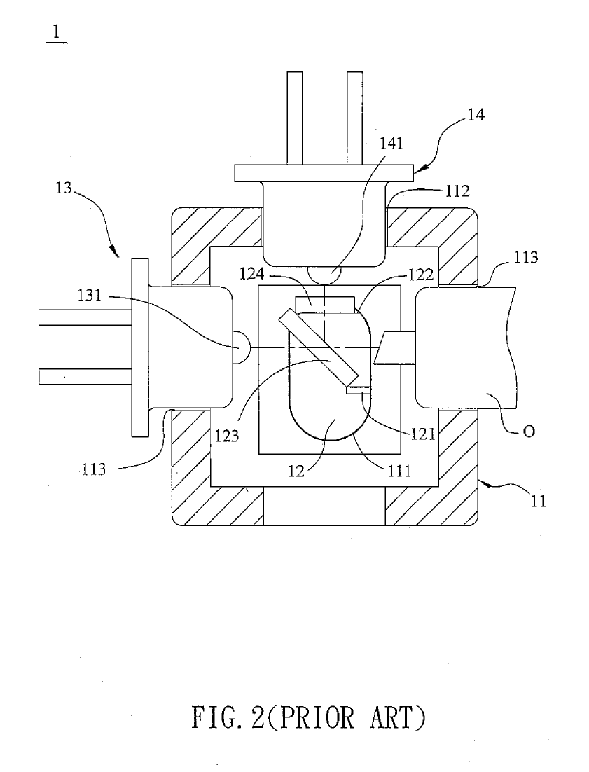

FIG. 3 is an exploded diagram showing an optomechanical device according to an embodiment of the present invention; and

FIG. 4 is a cross-sectional diagram showing the optomechanical device of FIG. 3.

### DETAILED DESCRIPTION OF THE INVENTION

The present invention will be apparent from the following detailed description, which proceeds with reference to the accompanying drawings, wherein the same references relate to the same elements.

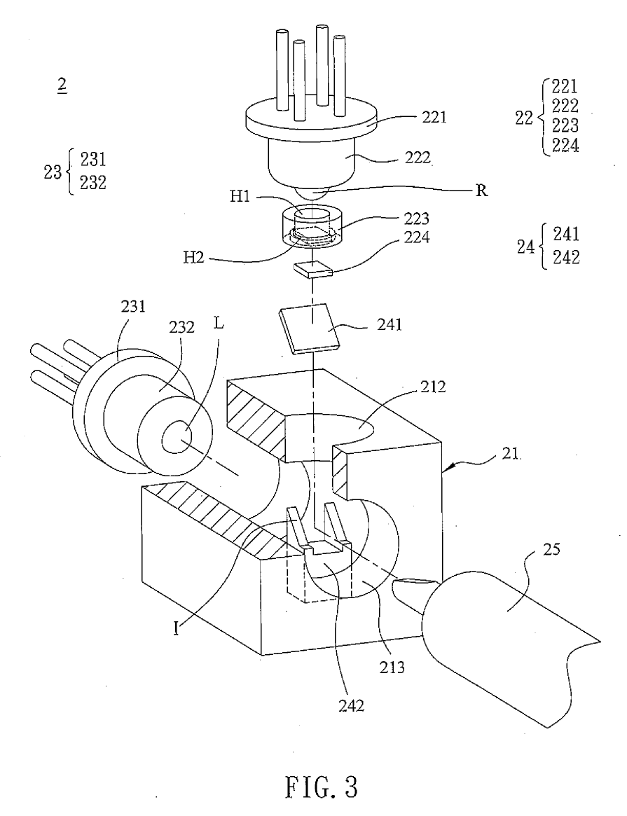

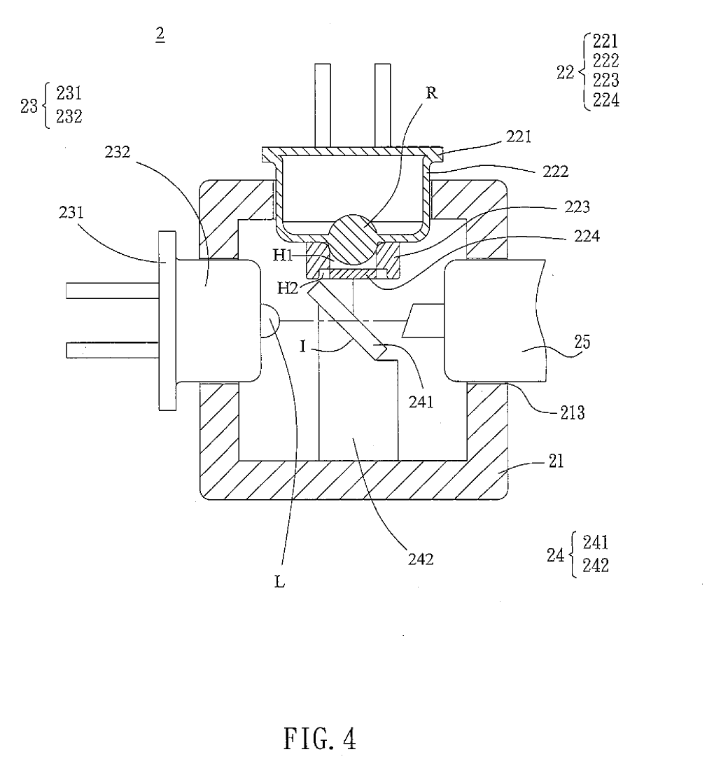

FIG. 3 is an exploded diagram showing the structure of an optomechanical device 2 according to an embodiment of the invention. FIG. 4 is a cross-sectional diagram showing the assembled optomechanical device 2 of FIG. 3. The optomechanical device 2 includes a housing 21, a first optical transmitting element 22, a second optical transmitting element 23 and a filtering element 24. The first optical transmitting element 22, the second optical transmitting element 23 and the filtering element 24 are configured in the housing 21. In the embodiment, the optomechanical device 2 can be an optical transceiver, the first optical transmitting element 22 can be a Receiver Optical Sub-Assembly (ROSA), and the second optical transmitting element 23 can be a Transmitter Optical Sub-Assembly (TOSA).

In the embodiment, the housing 21 has a first through hole 212 and a second through hole 213. The first through hole 212 and the second through hole 213 are configured approximately perpendicular to each other. To be noted, the first through hole 212 is connected to the second through hole 213 to form, for example but not limited to, a T shape. In addition, the filtering element 24 of the optomechanical device 2 is disposed in the housing 21 and positioned between the first optical transmitting element 22 and the second optical transmitting element 23. The filtering element 24 includes a filtering plate 241 and a holder 242, which has an oblique surface I. The filtering plate 241 is disposed on the oblique surface I of the holder 242. The holder 242 is disposed between the first through hole 212 and the second through hole 213.

As mentioned above, the holder 242 of the filtering element 24 is fixed to the housing 21 by way of, for example, adhering or locking. Of course, the holder 242 can also be formed by other methods. For example, the holder 242 and the housing 21 can be integrally formed as a single unit so that the holder 242 and the oblique surface I can be manufactured by the lathe processing. To be noted, the oblique surface I and the housing 21 form an angle, which is, for example but not limited to, 45 degrees. In the embodiment, the filtering plate 241 is a 45-degree filter.

The first optical transmitting element 22 is disposed in the housing 21 and passes through the first through hole 212. The first optical transmitting element 22 includes a first body 221, a first transmitting portion 222, a first carrying potion 223 and a first filtering portion 224. The first transmitting portion 222, the first holding portion 223 and the first filtering portion 224 are sequentially configured on the body 221. In the embodiment, the first transmitting portion 222 and the first holding portion 223 are connected to the body 221, and the first filtering portion 224 is disposed corresponding to the first transmitting portion 222 and positioned on the first holding portion 223 for allowing the optical signal with one wavelength to pass the first filtering portion 224 and to be received by the first transmitting portion 222. In addition, the first holding portion 223 has a first hole H1 and a second hole H2, which are disposed opposite to each other. The first hole H1 is connected to the second hole H2, and the first hole H1 and the second hole H2 can have the same shape or different shapes. In the embodiment, the first hole H1 is circular and the second hole H2 is rectangular, for example.

In addition, the first transmitting portion 222 has a receiving terminal R, which protrudes from a surface of the first body 221 and is disposed in the first hole H1. The first filtering portion 224 of the first optical transmitting element 22 is disposed in the second hole H2. Therefore, the receiving terminal R of the first transmitting portion 222 is disposed opposite to the first filtering portion 224. In the embodiment, the first carrying portion 223 can be annular, and the first filtering portion 224 can be a filter, such as a zero-degree filter, and the receiving terminal R, for example, is a light-emitting diode (LED) or an optical detector.

In the embodiment, the second optical transmitting element 23 is disposed in the housing 21 and passes through the second through hole 213. The second optical transmitting element 23 has a second body 231 and a second transmitting portion 232, which is coupled to the second body 231. The second transmitting portion 232 has a light source terminal L, which is disposed at one end of the second transmitting portion 232. The light source terminal L can be a laser diode, which emits a laser beam. In addition, the optomechanical device 2 of the embodiment further includes an optical transmission line 25. The optical transmission line 25 is, for example, a fiber, which passes through the second through hole 213 and is disposed in the housing 21 and opposite to the second optical transmitting element 23.

The first optical transmitting element 22 is disposed in the first through hole 212 and adjacent to the filtering element 24, and the second optical transmitting element 23 is disposed in the second though hole 213 and opposite to the optical transmission line 25. To be noted, the first optical transmitting element 22 of the optomechanical device 2 receives the optical signal from the optical transmission line 25 and transforms the optical signal into the electrical signal, and the second optical transmitting element 23 transforms the electrical signal into the corresponding optical signal and transmits the optical signal through the optical transmission line 25.

In the present invention, the first filtering portion 224, the first holding portion 223 and the first transmitting portion 222 are integrated with the first body 221. The first holding portion 223 is disposed on the first transmitting portion 222. The first filtering portion 224 is disposed on the first holding portion 223 and is positioned opposite to the first transmitting portion 222. Therefore, the first filtering portion 222 can be easily fixed to the first holding portion 223 of the first optical transmitting element 22 and aligned to the first filtering portion 224 without the precise orientation structure and the precise alignment tool. Therefore, the precision lathe used to manufacture the conventional optomechanical device is unnecessary in the invention because the first filtering portion 224 of the invention is disposed on the housing 21. In addition, the first filtering portion 224 can include the filtering plate with smaller dimension, so that the material cost for manufacturing the optomechanical device 2 can be reduced.

In summary, in the optomechanical device of the present invention, the first filtering portion of the first optical transmitting element is disposed on the first holding portion of the first optical transmitting element, and the first holding portion is telescoped on the first body of the first optical transmitting element. Compared to the prior art, the first filtering portion of the present invention is disposed on the first holding portion of the first optical transmitting element, so that the precision lathe for manufacturing the conventional optomechanical device is not needed due to that the filter is disposed on the housing. Therefore, in the present invention, the quality of the optomechanical device can be improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optomechanical device comprising:
a housing;
a first optical transmitting element and a second optical transmitting element disposed in the housing; and
a filtering element disposed between the first optical transmitting element and the second transmitting element,
wherein the first optical transmitting element comprises a first body, a first transmitting portion coupled to the first body, a first holding portion connected to the first transmitting portion, and a first filtering portion disposed corresponding to the first transmitting portion and fixedly positioned on the first holding portion for allowing an optical signal with one wavelength to pass the first filtering portion to be received by the first transmitting portion.

2. The optomechanical device according to claim 1, wherein the housing has a first through hole and a second through hole configured approximately perpendicular to each other, the first optical transmitting element is disposed in the housing and passes through the first through hole, and the second optical transmitting element is disposed in the housing and passes through the second through hole.

3. The optomechanical device according to claim 2, wherein the filtering element comprises a filtering plate and a holder for carrying the filtering plate, and the holder is disposed between the first through hole and the second through hole.

4. The optomechanical device according to claim 3, wherein the holder has an oblique surface and the filtering plate is disposed on the oblique surface.

5. The optomechanical device according to claim 3, wherein the holder and the housing are integrally formed as a single unit, or the holder is fixed on the housing by way of adhering or locking.

6. The optomechanical device according to claim 1, wherein the first holding portion has a first hole and a second hole opposite to each other.

7. The optomechanical device according to claim 6, wherein the first transmitting portion has a receiving terminal protruding from a surface of the first body and disposed in the first hole.

8. The optomechanical device according to claim 7, wherein the first filtering portion of the first optical transmitting element is disposed in the second hole, and the receiving terminal is disposed opposite to the first filtering portion.

9. The optomechanical device according to claim 7, wherein the receiving terminal comprises a light-emitting diode or an optical detector.

10. The optomechanical device according to claim 6, wherein a shape of the first hole is substantially the same as or different from that of the second hole, and the first hole is circular and the second hole is rectangular.

11. The optomechanical device according to claim 1, wherein the first holding portion is annular, and the first filtering portion comprises a filter or a zero-degree filter.

12. The optomechanical device according to claim 1, wherein the second optical transmitting element comprises a second body, a second transmitting portion coupled to the second body, and the second transmitting portion comprises a light source disposed at one end of the second transmitting portion for emitting a laser beam or a light.

13. The optomechanical device according to claim 2, further comprising an optical transmitting line passing through the second through hole and disposed opposite to the second optical transmitting element.

14. The optomechanical device according to claim 1, wherein the first optical transmitting element comprises a receiver optical sub-assembly (ROSA), and the second optical transmitting element comprises a transmitter optical sub-assembly (TOSA).

15. An optical transmitting element comprising:
a body;
a transmitting portion coupled to the body;
a holding portion connected to the transmitting portion; and
a filtering portion disposed corresponding to the transmitting portion and positioned on the holding portion for allowing an optical signal with one wavelength to pass the first filtering portion to be received by the first transmitting portion.

16. The optical transmitting element according to claim 15 being a receiver optical sub-assembly (ROSA).

17. The optical transmitting element according to claim 15, wherein the holding portion is annular, and the filtering portion comprises a filter or a zero-degree filter.

18. The optical transmitting element according to claim 15, wherein the carrying portion has a first hole and a second hole opposite to the first hole, and the transmitting portion has a receiving terminal protruding from a surface of the body and disposed in the first hole, and the filtering portion is disposed in the second hole opposite to the transmitting portion.

19. The optical transmitting element according to claim 18, wherein the receiving terminal comprises a light-emitting diode or an optical detector.

20. The optical transmitting element according to claim 18, wherein a shape of the first hole is substantially the same as or different from that of the second hole.
